(19) United States
(12) Patent Application Publication
(10) Pub. No.: US 2015/0309702 A1
(43) Pub. Date: Oct. 29, 2015

(54) METHOD AND SYSTEM FOR GENERATING A USER INTERFACE FOR DEVICE DIAGNOSTICS OF A VALVE ASSEMBLY AND IMPLEMENTATION THEREOF

(71) Applicant: Dresser, Inc., Addison, TX (US)

(72) Inventors: Peter Butler, San Ramon, CA (US); Karen McAdams, San Ramon, CA (US); Rama Krishna Raju Mundunuru, Dublin, CA (US); Urvashi Sahni, San Ramon, CA (US)

(21) Appl. No.: 14/638,812

(22) Filed: Mar. 4, 2015

Related U.S. Application Data
(60) Provisional application No. 61/976,243, filed on Apr. 7, 2014.

(51) Int. Cl. G06F 3/0484; G06F 3/0482; H04L 29/08; G06F 17/30

(52) U.S. Cl. CPC G06F 3/04842; G06F 17/30864; G06F 3/0482; H04L 67/10

(57) ABSTRACT

A system with a server configured to generate data for display on a first computing device. The server configured to receive a query over a network from a web browser launched on the first computing device and to generate an output with data for transmission over the network to the first computing device. The data generates a user interface on the web browser that configures the web browser to display information about the plurality of valve assemblies. In one example, the user interface is configured to conform to a form factor that defines physical attributes of the display on the first computing device. The user interface is also configured to receive a user selection from an end user that defines the query to change the information on the user interface to relate to an individual valve assembly from among the plurality of valve assemblies.

### CROSS-REFERENCE TO RELATED APPLICATIONS

This application claims the benefit of priority to U.S. Provisional Application Ser. No. 61/976,243, filed on Apr. 7, 2014, and entitled “USER INTERFACE.” The content of this application is incorporated herein by reference in its entirety.

### BACKGROUND

The subject matter disclosed herein relates to diagnostics and diagnostic tools to monitor performance of valve assemblies with particular discussion about a method and system to generate a user interface on a web browser that allows an end user to navigate to real-time data that relates to operation of an individual valve assembly.

Process lines may include many varieties of flow controls. These process lines typically transfer fluids for use in the chemical industry, refining industry, oil & gas recovery industry, and the like. Examples of the flow controls include pneumatic and electronic valve assemblies (collectively, “valve assemblies”) that regulate a flow of process fluid (e.g., gas and liquid). In conventional implementation, these valve assemblies have a number of components that work together to regulate flow of process fluid into and/or out of the process line. These components include a closure member, a seat, a valve stem, and an actuator. Examples of the closure member may embody a plug, ball, butterfly valve, and/or like implement that can contact the seat to prevent flow. In common constructions, the actuator couples with the closure member (via the valve stem). The valve assembly may also incorporate a valve positioner with electrical and/or electro-pneumatic components. During operation, the valve positioner receives control signals from a controller that is part of a process control system (also “distributed control system” or “DCS”). These control signals define operating parameters for the valve assembly, namely, a position for the closure member relative to the seat. In response to the control signal, the valve positioner delivers a pneumatic signal that regulates instrument gas to pressurize the actuator in order to regulate this position.

Problems with valve assemblies on the process line may disrupt the process and/or prevent the process line from achieving the necessary process parameters. The resulting disruptions can lower yields and reduce quality. In large refineries, chemical plants, and power plants, disruptions can also lead to significant expense from process downtime that is necessary to troubleshoot and repair the problematic devices. Plant operators therefore have an interest to perform diagnostics on the valve assemblies to detect problems at the device-level, for example, before problems manifest in ways that can hinder sustainable operation of the process line.

Individuals that perform diagnostics can leverage tools that present infoimation in a manner that facilitates in the individual an understanding of the process and operation of the devices associated therewith. These tools include software packages that can process data that relates to operation of the process devices. These software packages can also display the data for an end user to observe, typically on a computer or workstation. In this manner, the end user can evaluate operation of the process devices from the data displayed thereon.

Migration of display requirements to web-based user interfaces has exposed some limitations in conventional tools. Many of these tools are often unable to convey “live” or real-time data to a browser; instead providing static displays with limited functionality. Moreover, these tools are likely built in a manner that is platform-specific and, thus, are not readily compatible with mobile devices that have screens that come in a variety shapes, sizes, and differing form factors.

### BRIEF DESCRIPTION OF THE INVENTION

This disclosure describes improvements to diagnostic tools that provide the end user with a robust, rich environment to perform diagnostics. The embodiments herein deliver data and information to offer an experience for the end user that both simplifies the way in which they interact with the data and frees them from the device-level constraints that dominate conventional practice. Broadly, these embodiments leverage web browser technology to deliver a user interface that requires the end user to employ only a minimum number of “clicks” to achieve a sufficient understanding about how an individual device is operating in the field. This user interface is compatible across device-level and system-level platforms. This feature offers the end user an opportunity to seamlessly leverage information on device operation on computing devices that have different form factors and across multiple devices at the same time. In this way, the embodiments change the paradigm from the pre-dominantly desktop-based systems of conventional practice to mobile and/or mobile and desktop configurations that equip the end user to perform device diagnostics from any location and at any time, as desired.

### BRIEF DESCRIPTION OF THE DRAWINGS

Reference is now made briefly to the accompanying drawings, in which:

FIG. 1 depicts a schematic diagram of an exemplary embodiment of a system to generate a user interface that presents information about process devices to an end user;

FIG. 2 depicts the system of FIG. 1 in use with a DCS control system and process line;

FIG. 3 depicts a screen shot of an example of a configuration for the user interface that results from operation of the system of FIGS. 1 and 2;

FIG. 4 depicts a screen shot of an example of a configuration for a user interface that results from operation of the system of FIGS. 1 and 2;

FIG. 5 depicts a screen shot of an example of a configuration for a user interface that results from operation of the system of FIGS. 1 and 2;

FIG. 6 depicts a screen shot of an example of a configuration for a user interface that results from operation of the system of FIGS. 1 and 2;

FIG. 7 depicts a screen shot of an example of a configuration for a user interface that results from operation of the system of FIGS. 1 and 2;

FIG. 8 depicts a screen shot of an example of a configuration for a user interface that results from operation of the system of FIGS. 1 and 2;

FIG. 9 depicts a screen shot of an example of a configuration for a user interface that results from operation of the system of FIGS. 1 and 2;

FIG. 10 depicts a screen shot of an example of a configuration for a user interface that results from operation of the system of FIGS. 1 and 2;

FIG. 11 depicts a screen shot of an example of a configuration for a user interface that results from operation of the system of FIGS. 1 and 2;

FIG. 12 depicts a screen shot of an example of a configuration for a user interface that results from operation of the system of FIGS. 1 and 2; and

FIG. 13 depicts a flow diagram of an exemplary embodiment of a method that configures a remote terminal to generate data for display on a user interface of a web browser.

Where applicable like reference characters designate identical or corresponding components and units throughout the several views, which are not to scale unless otherwise indicated. Moreover, the embodiments disclosed herein may include elements that appear in one or more of the several views or in combinations of the several views.

### DETAILED DISCUSSION

Advances in technology that relate to data transmission, data storage, and data processing allow plant owners and operators to monitor performance of devices at a very granular level. By implementing appropriate analysis, plant owners and operators can often predict with great accuracy the potential for failure in a singular device before problems can occur and disrupt operation of a plant or a process line. Such foresight is critical for the plant operator to make judgments about maintenance and repair schedules, to reduce labor costs, and to maintain efficient operation of the plant or process line.

Conventional tools that allow the plant operator to perform device diagnostics have not kept pace with the ever-expanding amount of data. It has been found, for example, that many conventional tools have interfaces that complicate access to the wealth of information that is available to the individuals that are responsible for oversight of the facility. These interfaces often embody antiquated models that only afford the end user with access from a single point or location, e.g., a desktop computer. This model fails to exploit other modalities the end user might use to view and interact with the information, effectively reducing much of the efficiencies that the plant operator might gain by leveraging wired and wireless technologies and related devices (e.g., smart phones, tablets, etc.).

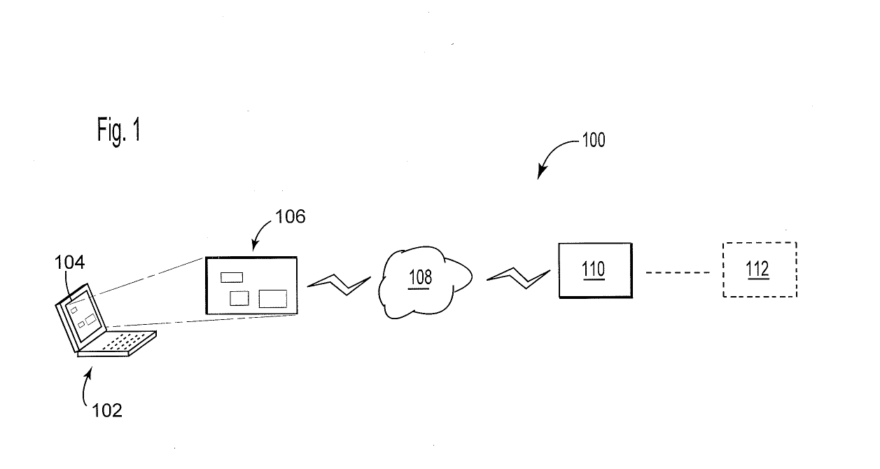

FIG. 1 depicts a schematic diagram an exemplary embodiment of a system 100 that can deliver diagnostic data about operation of valve assemblies on a process line to an end user. Moving from left to right in the diagram, the system 100 includes a remote terminal 102 (also, “first computing device 102”) with a display 104 that can display a user interface 106. Examples of the remote terminal 102 include smartphones and tablets, as well as conventional computing devices (e.g., laptops, desktops, etc.). Preferably, the user interface 106 displays on a web browser or like application. As also shown in FIG. 1, the remote terminal 102 communicates over a network 108 with a server 110 (also, “second computing device 110”). The server 110 is configured to obtain data from a remote source 112, typically the DCS system that controls the valve assemblies found on the process line or, more broadly, within one or more factories, plants, and/or installations. In use, the server 110 can operate as a web server, delivering data in a format to configure the user interface 106.

Unlike conventional control and diagnostic tools in the industrial process industry, the user interface 106 is configured with a screen that simplifies the experience of the end user at the terminal 102. This screen has a layout that allows the end user to focus on data that relates to operation of individual valve assemblies with minimal interaction with the user interface 106. Among its many features, the layout offers visual representations that display data in real-time. These visual representations provide the end user with an opportunity to visualize trends for more easy diagnosis of problematic conditions on each individual valve assembly. Moreover, the user interface 106 is compatible with a wide range of form factors for the display 104 on the remote terminal 102. This feature allows the end user to leverage the convenient layout of the screen on different types and sizes of the remote terminal 102. Thus, whereas conventional technology tethers the end user to desktop platforms, the user interface 106 of the present disclosure accommodates many different device platforms to free the end user to leverage mobile technology to obtain the benefits of the user experience provided by the screen layout proposed herein.

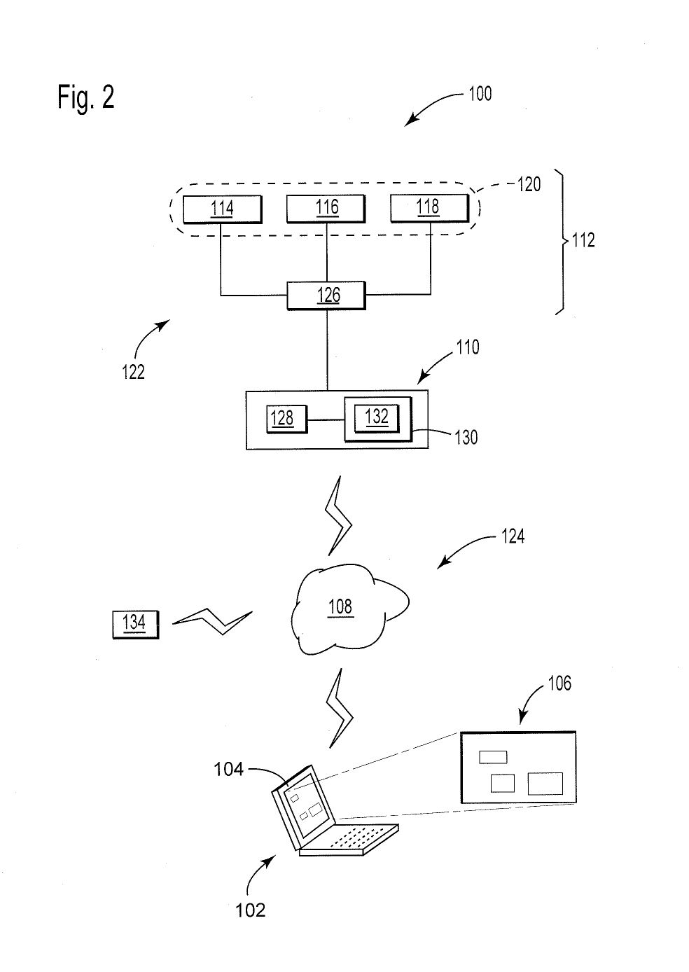

FIG. 2 illustrates a schematic diagram of an example of the system 100 to elaborate on details of an implementation of the concepts herein. In the illustrated example, the system 100 can embody a control structure that manages operation of a plurality of devices (e.g., a first process device 114, a second process device 116, a third process device 118) on a process line 120. Each of the process devices 114, 116, 118 can embody individual valve assemblies, also often referred to as “control valve assemblies.” The process line 120 can be found in a plant or a factory that service industries in the chemical, petrochemical, resource recovery and processing, and related fields of technology.

At a high level, the control structure includes a process structure 122 and a network structure 124. This control structure is useful to manage operation of the valve assemblies 114, 116, 118 to modulate flow of process fluids through the process line 120. The process structure 122 can include a controller 126 that operates as part of the DCS system to communicate the control signal to the valve assemblies 114, 116, 118. As noted above, this control signal causes the valve assemblies 114, 116, 118 to regulate the position of the closure member relative to the seat. The server 110 couples with the controller 126 to gather and process data and information about the valve assemblies 114, 116, 118, typically data that reflects the operating parameters—position, setpoint, and actuator pressure—for each individual valve assembly 114, 116, 118 on the process line 120. The server 110 can include a processor 128, a memory 130 that couples with the processor 128, and executable instructions 132 that are stored on the memory 130. The executable instructions 132 can comprise all or part of computer programs (e.g., software and firmware) and like compilations of instructions (collectively, “software”) that are configured to be executed by the processor 128.

The network structure 124 can be configured to facilitate data transmission between the server 110 and the remote terminal 102. The network structure 124 can include the network 108, which couples with the remote terminal 102 and with one or more remote devices (e.g., an external server 134). The external server 134 may be configured to collect and store data, as well as to perform other peripheral functions, for example, to store software for use to distribute data to the remote terminal 102 for display on the user interface 106.

With continuing reference to FIGS. 1 and 2 throughout, the discussion now continues with a focus on aspects of the user interface 106. At a high level, examples of the user interface 106 allow the end user to view data and information about one or more valve assemblies. These examples can utilize a number of interactive features that the end user can select (e.g., by pointing and clicking with a mouse, by tapping on a screen, etc.) to navigate into data and other information that defines the performance of individual valve assemblies. As noted above, the user interface 106 differs from conventional tools at least because the features of the present disclosure can maximize efficiency of the end user by allowing the end user to navigate to desired information with a minimum number of screens and/or interactions (or “clicks”).

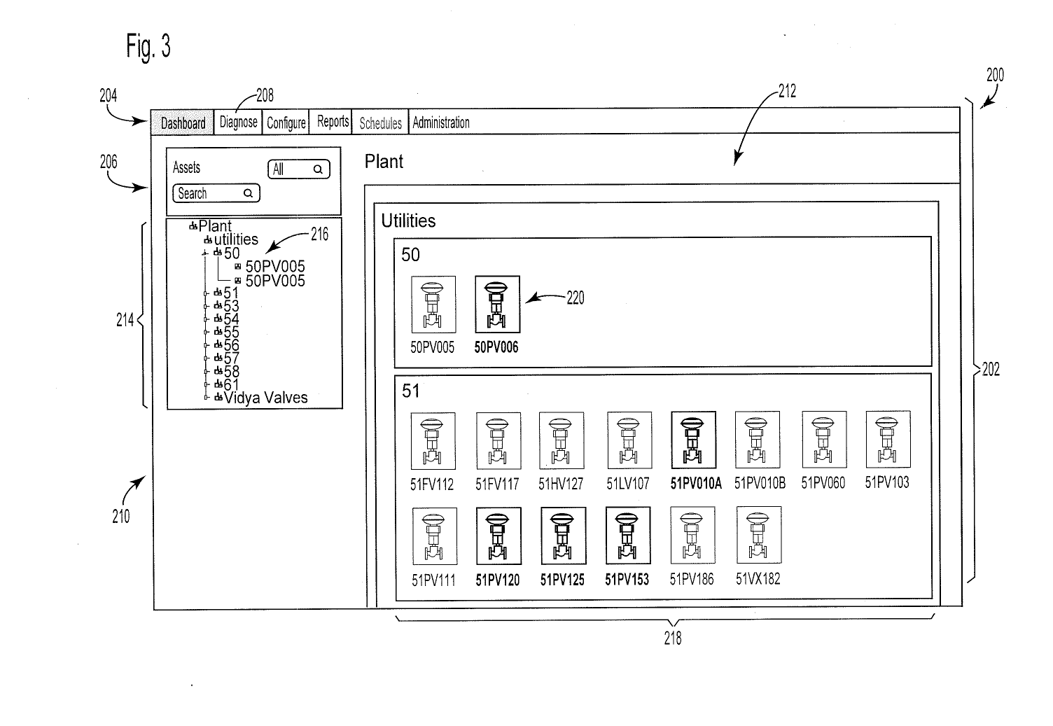

FIG. 3 depicts a schematic diagram of screen shot of an example of a user interface 200 that resolves on the web browser. The user interface 200 can generate a screen 202 with a navigation region 204 and a content region 206. The navigation region 204 can include one or more navigation icons 208. Selection of the navigation icons 208 are useful for the end user to modify the information visualized in the content region 204. In the present example, selection of the “dashboard” or first icon in the navigation region 204 results in the configuration of the screen 202. This first icon offers a launching point, or “home screen,” for the end user to dive deeper into the data that is available for individual valve assemblies. As noted more below, the navigation region 204 can include other icons that allow the end user to modify the configuration of the screen 202. These icons may include the “diagnose” or second icon, the “configure” or third icon, the “reports” or fourth icon, the “schedules” or fifth icon, and the “administration” or sixth icon.

In FIG. 3, the content region 206 can include one or more content areas (e.g., a first content area 210 and a second content area 212), each of which can visualize different information for the end user as contemplated herein. To the far left of the screen 202, the first content region 210 displays a device tree 214 with a plurality of device entries 216. Each of the device entries 216 corresponds with an individual valve assembly. The end user can use the device tree 214 to navigate to data (displayed in the second content area 212) that relate to the selected individual valve assembly.

In the middle of the screen 202, the second content area 212 displays a device map 218 that uses a device instance 220 to identify each of a plurality of individual valve assemblies. The number of valve assemblies shown in the device map 218 may reflect, for example, the number of valve assemblies under control of a particular control system or the number of valve assemblies that couple with a particular process line. Examples of the device instance 220 can feature a visual representation, e.g., an image and/or icon. This visual representation may embody a typical structure for the valve assembly as shown in FIG. 3; however this disclosure contemplates that the embodiments herein can accommodate some level of customization as to the nature of the visual representation. In one implementation, the device entries 216 in the device tree 214 correspond with only a subset of the individual valve assemblies found in the device map 218. The end user may designate (or select) this subset, as described further below, to customize the device tree 214 to include only certain ones of the individual valve assemblies in the device map 218. This feature may be useful for the end user to track and to perform diagnostics on only a handful of valve assemblies, as desired.

The device tree 214 and the device map 218 can arrange the individual valve assemblies according to an identifier (shown here as the numbers “50” and “51”). This identifier effectively groups related valve assemblies together. The identifier may relate the respective valve assemblies to a process, a process line, a geographic location, and/or like identification. In one example, the device tree 214 can use the identifier to arrange the device entries 216 in a hierarchy or like file formatting structure.

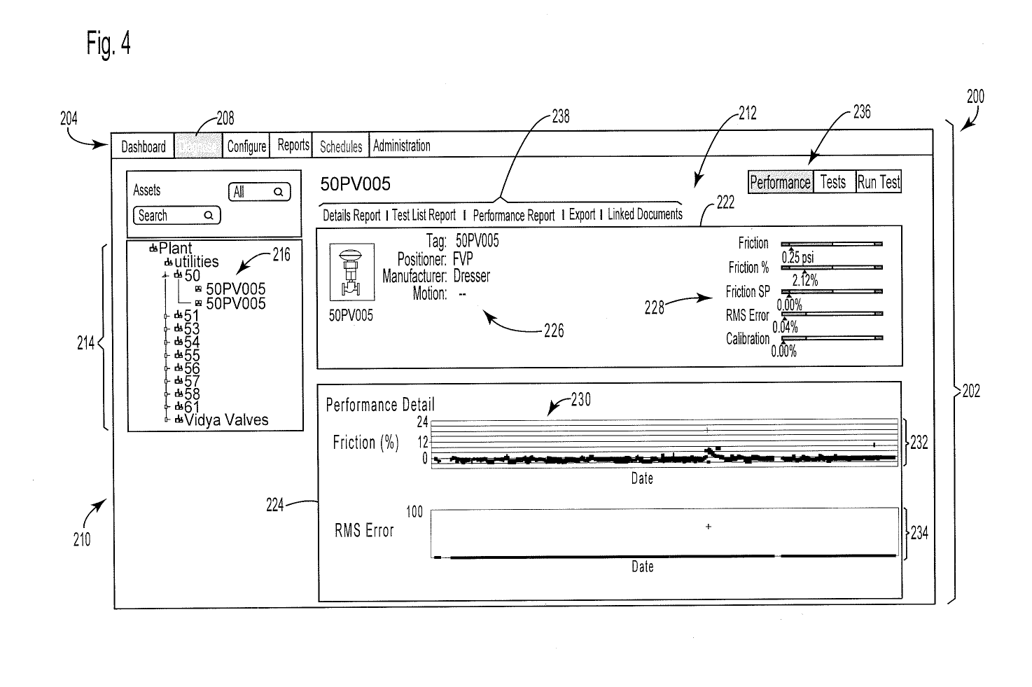

FIG. 4 depicts an example of a configuration of the screen 202 that results from a query that corresponds with selection of the “diagnose” or second icon in the navigation region 204. The first content area 210 includes a search feature, found just above the device tree 214. This search feature allows the end user to enter search terms, e.g., that identify an individual valve assembly. Moreover, the device entries 216 in the device tree 214 can embody a selectable icon that defines the query exchanged from the web browser to the server. The data in the second content area 212 corresponds with an individual valve assembly, preferably selected from among one of the device entries 216 (here the device entry “50PV005” as noted by the title “50PV005” in the upper, left part of the second content area 212).

Turning to the middle of the screen 202 in FIG. 4, the second content area 212 can include one or more device data areas (e.g., a first device data area 222 and a second device data area 224). The first device data area 222 can include various content including non-operative content 226 and performance content 228. Examples of the non-operative content 226 can include attributes (noted herein as “non-operative attributes”) in a format that allows the end user to identify the valve assembly and, if necessary, associate an action to the attributes and schedule the action, e.g., through different modalities such as electronic mail, phone, etc. Exemplary actions can include scheduling maintenance to check on the individual valve assembly in the field. The performance content 228 can include data that helps reconcile the appropriate action. This data can define operation of the device, notably, as described by one or more related performance indicators (discussed below in connection with the method 300). The performance content 228 may use a visual indicator (e.g., a linear scale, number, graph, etc.) that the end user can view and from which the end user can effectively formulate and/or make a judgment as to the performance of the individual valve assembly that is the subject of the second content area 212.

As shown in the lower part of the screen 202 of FIG. 4, the second device data area 224 can also include detailed content 230 that provides further data and detail as relates to, in one example, the performance content 228 shown in the first device data area 222. The detail content 230 can include one or more visual representations, shown on the screen 202 as one or more plots (e.g., a first data plot 232 and a second data plot 234). Examples of the plots 232, 234 can include data samples that define an operative parameter for the individual valve assembly. The operative parameter may correspond with the performance indicator(s) in the first device data area 222; however the plots 232, 234 may also show other data that relates to, e.g., position, pressure, setpoints, and like operating settings for the individual valve assembly.

Above the first device data area 222 in the example of FIG. 4, the second content area 212 also includes one or more sub-navigation regions (e.g., a performance navigation region 236 and a report navigation region 238). Use of the icons in the report navigation region 238 can display additional details that correspond at least in part with the data and information displayed on the screen 202 and/or that relates to the individual valve assembly, generally. This information may appear in one or more additional “pop-up” windows and/or tabs of the user interface 200 or as defined by parameters for the web browser. In the upper right part of the screen 202, the performance navigation region 236 can include icons that the end user can utilize to configure the data on the screen 202. Selection of one of the “performance” icon, the “test” icon, and the “run test” icon can configure the second device data area 224 in the lower part of the screen 202. For example, the diagram of FIG. 4 corresponds with selection of the “performance” icon.

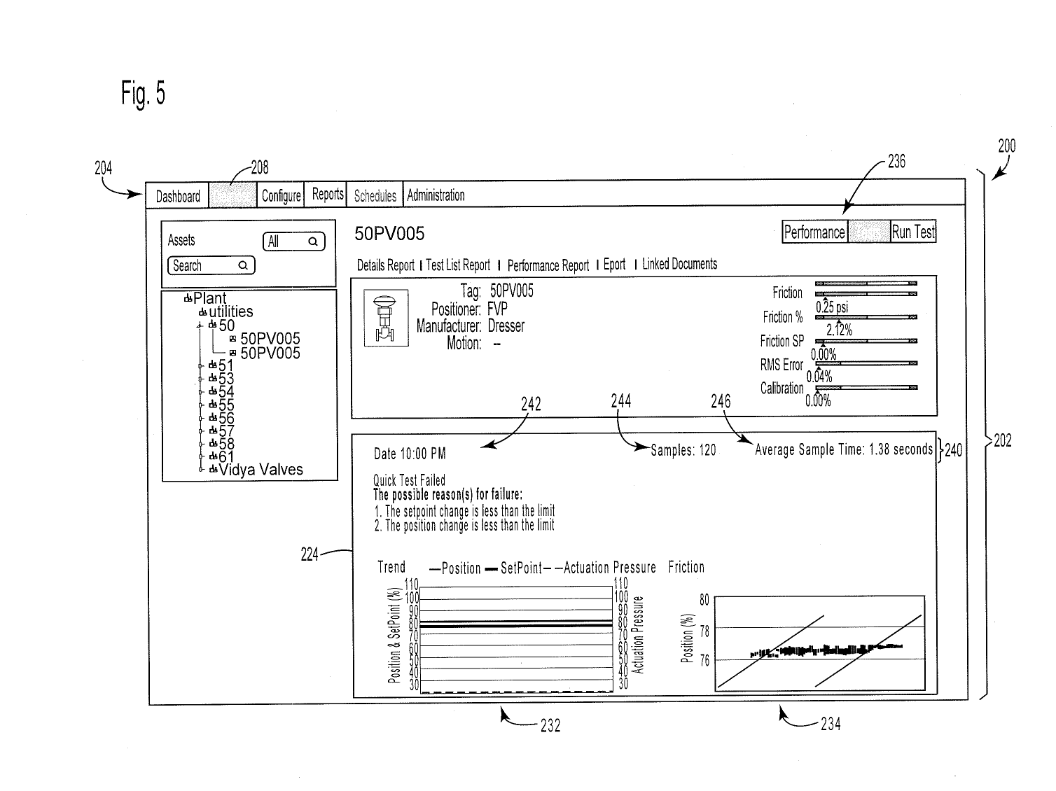

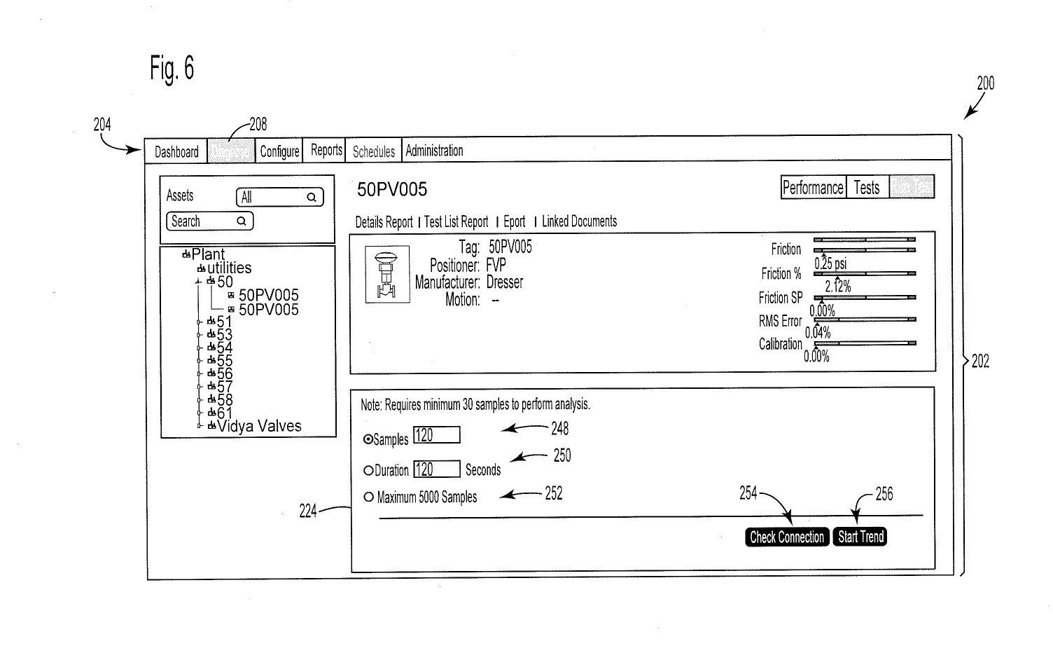

FIGS. 5 and 6 depict an example of a configuration of the screen 202 that results from a query that corresponds with selection of the “test” icon (FIG. 5) and the “run test” icon (FIG. 6) in the performance navigation region 236. In FIG. 5, focusing on the middle, lower part of the screen 202, the second device data area 224 provides test content 240 that includes test identification data (e.g., date/time 242, number of data samples 244, and a sample rate 246). The test content 240 reflects information for one or more “diagnostic tests” of the individual valve assembly. Generally, these diagnostic tests contemplate operation of the server 110 to retrieve data about one or more valve assemblies from the DCS system. This data can help the end user understand the operation of the individual valve assembly, typically as relates to one or more of the performance indicators and/or operating settings discussed herein. Each diagnostic test may correspond with a discrete subset of data samples. In one implementation, the data plots 232, 234 can display data samples that are collected and/or gathered in real-time, e.g., contemporaneously with display of the data on the screen 202 (considering some time lag associated with data collection and transmission between the server and the computing device, where applicable). In other implementations, the data plots 232, 234 can display data samples for the test that were previously-acquired and stored in memory.

The configuration of the screen 202 in FIG. 6 relates to the “run test” icon. This configuration allows the end user to define parameters for the diagnostic test and to initiate the server 110 to retrieve data in accordance therewith. The second device data area 224 includes one or more settings (e.g., a sample setting 248, a sample time 250, and a sample set limiter 252). In the bottom, right corner of the screen 202, the second device data area 224 also includes one or more test initiation icons (e.g., a connection icon 254 and a start icon 256). The connection icon 254 can ensure that the individual valve assembly is connected with the DCS system in order to obtain data about, e.g., the individual valve assembly that is the subject of the diagnostic test. The start icon 256 can result in a plot (not shown) in a separate window, tab, or in plots 232, 234 (FIG. 5), or like instantiation of the user interface 106 and/or the web browser to show data in real-time. The settings 248, 250, 252 are generally useful to define the parameters and/or boundaries of the diagnostic test. The sample setting 248 and the sample set limiter 252, for example, can define the number of data samples that are to be included within the diagnostic test, and which are displayed on the plots 232, 234 (FIG. 5). The sample time 250 can define the length of the diagnostic test; for real-time data collection and analysis, the value of the sample time 250 can set out how long data samples are to be collected during operation of the individual valve assembly.

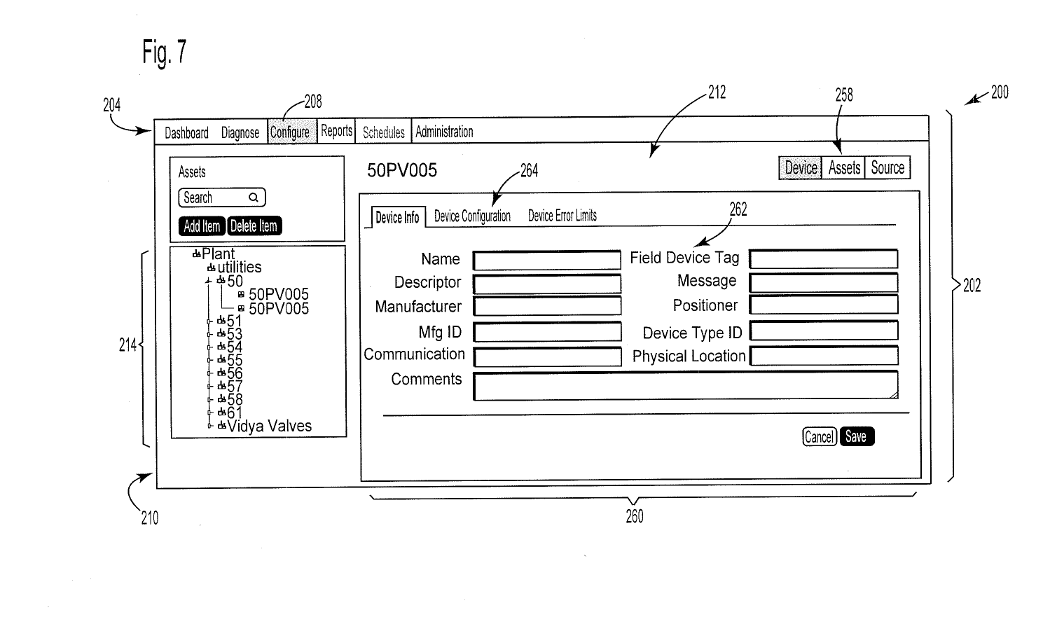

FIGS. 7, 8, and 9 depict an example of a configuration of the screen 202 that corresponds with selection of the “configure” icon from among the navigation icons 208 in the navigation region 204 (at the top of the screen 202). Broadly, this configuration allows the end user to actively customize the look, feel, and other relevant features of the user interface 200. In FIG. 7, with particular reference to the upper, right corner of the screen 202, the second content area 212 includes an asset navigation region 258 with one or more selectable icons. Selection of one of the selectable icons can change the configuration of one or more of the content areas 210, 212. For example, the second content area 212 in FIG. 7 reflects a selection of the “device” icon. This selection changes the second content area 212 to include an asset management area 260 with various configuration fields 262 and configuration tabs 264. The configuration field 262 can include data entry fields that correspond with one or more non-operative attributes mentioned herein. The data entry fields are useful for the end user to alter information that relates to the individual valve assembly. The configuration tabs 264 can allow the end user to navigate to other type of data entry fields (e.g., configuration fields 262), as desired.

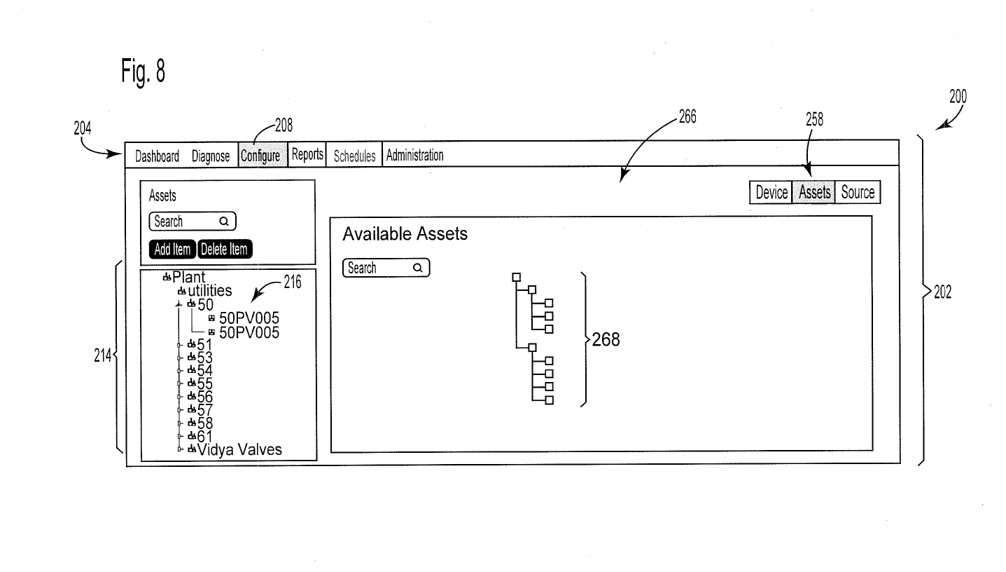

As best shown in FIG. 8, selection of the “assets” icon in the asset navigation region 258 changes the configuration of the screen 202 to include an asset area 266. In one example, the asset area 266 displays an asset tree 268. Examples of the asset tree 268 can identify the plurality of valve assemblies that might be available for diagnostics and/or that are otherwise “connected” to the DCS system and accessible to the server 110. In lieu of the asset tree 268, the asset area 266 may include other visual representations of valve assemblies (e.g., as shown in connection with FIG. 3). The end user can interact with the asset tree 268 to populate the device tree 214 with device entries 216 that reflect the newly-added valve assemblies. For example, the user interface 200 may be configured for the end user to “drag-and-drop” individual instances of the valve assemblies from the asset tree 268 to the device tree 214, and vice versa to remove certain valve assemblies from the device tree 214, as desired.

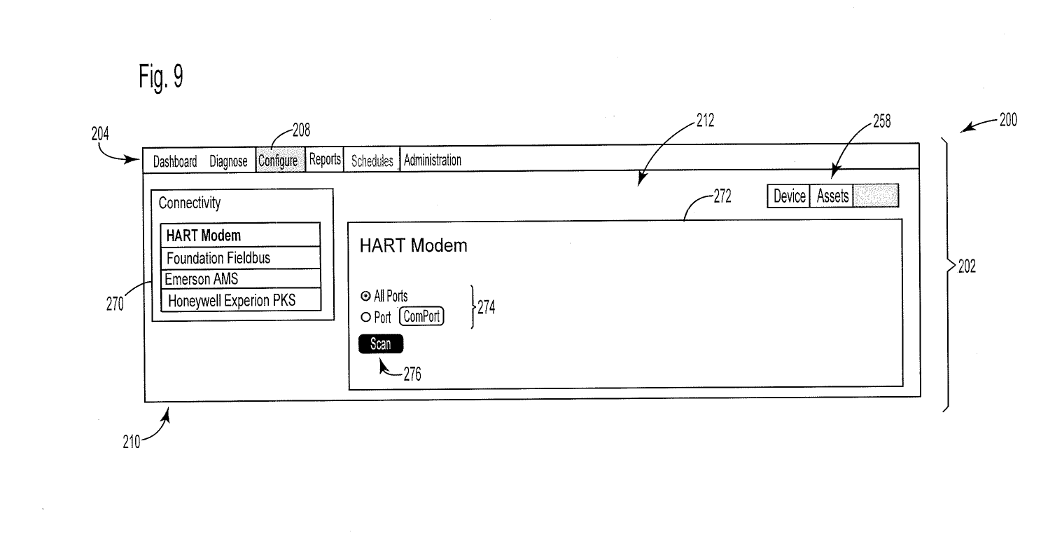

FIG. 9 illustrates use of the “source” icon in the asset navigation region 258 to provide the configuration for the screen 202. In this configuration, the first content area 210 on the left hand side of the screen 202 includes a connectivity selection area 270. In one implementation, the connectivity selection area 270 is configured for the end user to select among any number of available systems and communication protocols (e.g., HART, FOUNDATION® Fieldbus, Emerson AMS, Honeywell Experion PKS, etc.). This feature is useful if the server 110 is connected to multiple DCS systems. Also in FIG. 9, the second content area 212 includes one or more connection fields 272 that allow the end user to define an asset search criteria 274. In general, the asset search criteria 274 identifies the one or more connection points between, e.g., the server 110 and the DCS systems. These connection points correspond, in one example, with ports on the server 110, including physical ports that receive connectors from suitably configured cables as well as wireless ports that facilitate wireless connections. Use of a scan icon 276 by the end user can initiate the appropriate search of the connection points and, moreover, change the configuration of the asset area 266 (FIG. 8) to populate the asset tree 268 (FIG. 8) with valve assemblies that are found in accordance with the search. In one example, the asset search criteria 274 can allow the end user to search the entirety of all systems identified in the connectivity selection area 270 by designating “all ports” on the server 110. For the HART Modem system, for example, the asset search criteria 274 can include an “all ports” criteria that will examine the entirety of the connection points on the server 110 that couple with the HART system. The asset search criteria 274 can also allow the end user to specify a specific connection point on the server 110 by using an identifier (the “ComPort” identifier in FIG. 9).

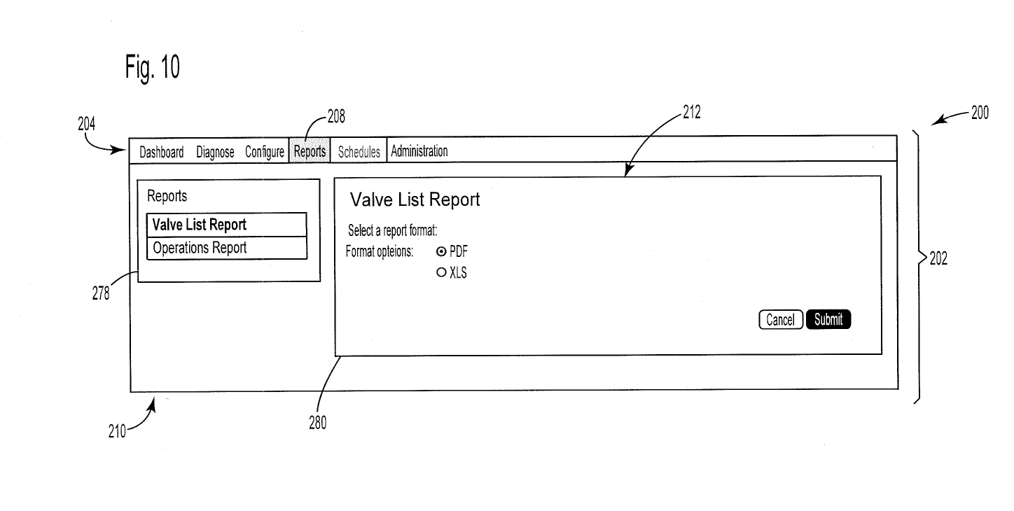

FIG. 10 depicts an example of a configuration of the screen 202 that corresponds with selection of the “reports” icon from among the navigation icons 208 in the navigation region 204. This configuration allows the end user to generate reports and other outputs that relate to the data about the individual valve assembly (and, where applicable, the valve assemblies at large). On the left hand side of the screen 202, the first content area 210 includes a reports selection area 278 with one or more report selections. The second content area 212 includes a report detail area 280, shown here with one or more report format selections that configure the second content area 212. Examples of the report format selections may be helpful to identify a format (e.g., pdf, xls, etc.) for the report, as well as other aspects (e.g., page size, page numbers, etc.) that might benefit the end user. In one implementation, selection of one of the report selections 278 will configure the report detail area 280 with specific content that relates, e.g., to the format selections (or other parts of the report detail area 280).

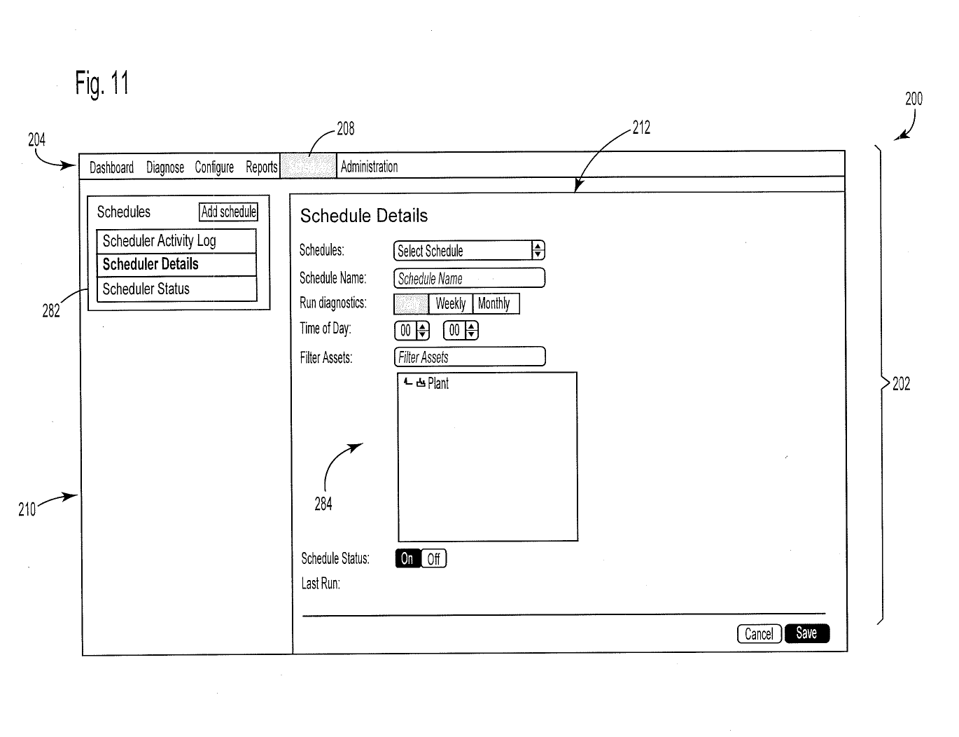

FIG. 11 depicts an example of a configuration of the screen 202 that corresponds with selection of the “schedules” icon from among the navigation icons 208 in the navigation region 204. The end user can use this configuration to develop and/or implement a diagnostic test that automatically collects data about operation of the valve assemblies. As shown in FIG. 11, the first content area 210 includes a scheduling selection area 282 with one or more scheduling selections. In the second content area 212, the configuration renders a schedule detail area 284 with one or more scheduling detail selections. These scheduling detail sections may cover a variety of parameters, including chronological parameters (e.g., date, time, etc.), naming parameters for the diagnostic test, asset selection parameters to identify the valve assemblies that are to be included in the diagnostic test, and the like.

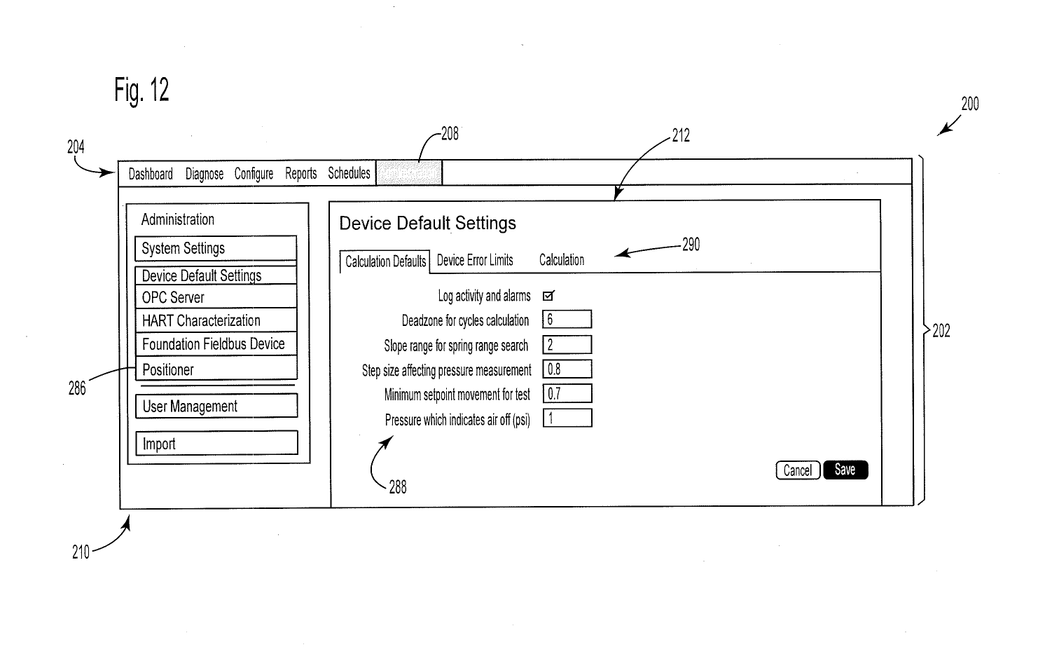

FIG. 12 depicts an example of a configuration of the screen 202 that corresponds with selection of the “administration” icon from among the navigation icons 208 in the navigation region 204. Broadly, this configuration of the screen 202 offers selections that the end user may employ to manage operation of the server 110, e.g., to manage software, operating systems, and other aspects of diagnostics and diagnostic testing equipment that are available and that communicate with the server 110. In the screen 202 of FIG. 12, the first content area 210 includes an administration selection area 286 with one or more administration selections. Examples of the administrative selections allow the end user to access certain configurable screens that relate to operation of the server 110 and/or its communication with the DCS system, or combinations thereof. The second content area can include a settings area 288 with one or more settings tabs 290. The settings in the settings area 288 include configurable parameters that define, for example, how the server 110 may collect data, may analyze data, and/or may output data. The screen 202 may provide the data entry and/or data selections for the configurable parameters that are available for the end user to use to configure the respective system, device, and/or application. In the particular configuration of FIG. 12, the parameters may relate to settings for performing analytics on data retrieved from the DCS. The settings tabs 290 allow the end use to change the selection of configurable parameters, as desired.

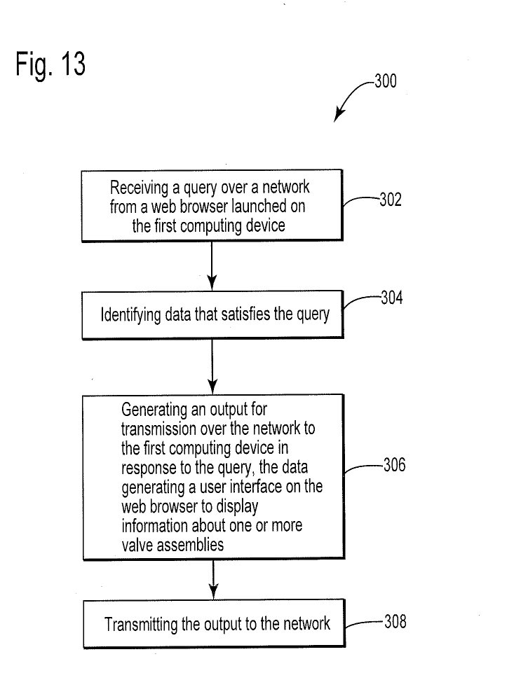

Referring also to FIGS. 1 and 2, FIG. 13 illustrates a flow diagram of an exemplary embodiment of a method 300 that can configure the server 110 to deliver data to the user interface 106 via web browser on a remote terminal 102. This data populates the user interface 106 with information that allows the end user to perform diagnostics on the valve assemblies 114, 116, 118 found, e.g., on the process line 120. The method 300 includes, at step 302, receiving a query over the network 108 from a web browser launched on the remote device 102 and, at step 304, identifying data that satisfies the query. The method 300 also include, at step 306, generating an output for transmission over the network 108 to the remote device 102 in response to the query, the data generating the user interface 106 on the web browser to display information about one or more valve assemblies 114, 116, 118. In one embodiment, the method 300 can further include, at step 308, transmitting the output to the network 108. These steps can be embodied by one or more instructions that are part of one or more computer-implemented methods (e.g., method 300) and/or programs on a computing device (e.g., the remote terminal 102, the server 110, etc.) and/or plurality of computing devices.

At step 302, the method 300 configures the server 110 to receive data from the web browser on the remote terminal 102. This data, in the form of the query, can initiate formulation of an output that transmits data to render the user interface 106 on the remote terminal 102. The server 110 may be outfit with one or more processors 128 and with access to executable instructions 132 stored on memory 130. The server 110 can operate to aggregate and process data and information. For industries that deploy valve assemblies, exemplary servers may couple with one or more control systems (noted herein as a “DCS system”) that operate valve assemblies. In this way, the server 110 can access data that relates to each of the valve assemblies, which may include valve assemblies on the process line 120, on multiple process lines in a factory (or facility), as well as in use within a particular company and/or entity.

The query may originate from one or more devices (e.g., a smartphone, tablet, laptop, etc.). The devices may be remote from the server 110 and may connect to the server 110 over the network 108. At a high level, the query operates as a request, or “call,” for the server 110 to perform processes that generate data that may be used to configure the user interface 106. The server 110, in turn, is configured to process the call. The query may be initiated by the end user, e.g., by interaction with the remote terminal 102 to select icons and/or other selectable areas. In the discussion herein, if not identified, it can be assumed that one or more embodiments of the method can be configured to assimilate any interaction of the end user with the user interface 106 with the query.

At step 304, the method 300 configures the server 110 to identify data that satisfies the query. This step may include steps for processing the query, which may direct the server 110 to perform other steps for accessing one or more repositories (e.g., a memory, a database, etc.) that have data that satisfies the query. The steps may also include steps for retrieving data from the repository, as necessary. Examples of the repositories may include databases with entries for each individual valve assembly. These entries may associate the individual valve assembly with “non-operative attributes” that may provide certain identifying information both to identify the individual valve assembly as well as to distinguish the individual valve assemblies from another. These non-operative attributes may capture a name (for the valve assembly), a description, a manufacturer, a manufacturer identification number, a field device tag, a positioner identifier, a device type ID, a physical location, a communication identifier, as well as general comments, etc. The entries in the database may also associate the individual device with the operating settings (e.g., setpoint, position, pressure, etc.) that define the operation of the valve assembly. The entries in the repository may further associate the valve assembly with information that defines the performance of the individual valve assemblies. Examples of such information can include performance indicators that define friction, spring range, lag, stick slip, and like indicators of performance. These performance indicators can be mathematically calculated from the data representing the operating parameters discussed herein.

At step 306, the method 300 configures the server 110 to generate the output. Examples of the output are configured to include the data identified in the step 304 above. This step can include steps for packaging the data in appropriate formats, one or more of which may be discussed herein. In one embodiment, the query and the output may leverage communication protocols and data formats that comport with web-based formats. These data formats may use uniform resource locators (URLs) and like web addresses and/or indicators in combination with hypertext transfer protocol (HTTP) to complete the requisite exchange of information between the first computing device and the second computing device. For purposes of simplifying the calls and outputs between the computing devices, the data formats may conform with representational state transfer (“REST”) structure that can use HTTP requests to perform various communication operations that create data, update data, read data, and delete data. This structure offers a lightweight alternative to Remote Procedure Calls and Web Services (e.g., SOAP, WSDL, etc.), among other architectures that are used by conventional data exchange techniques, particularly with respect to diagnostic data from, or about, valve assemblies found on a process line. This lightweight structure simplifies the calls and data requests and outputs that are generated in response to the calls. Device diagnostics and related data management for valve assemblies can benefit from this structure because the HTTP requests significantly reduce the coding and other tasks necessary to implement the REST structure for use with diagnostic data (e.g., data that relates to process devices like valve assemblies).

At step 308, the method 300 configures the server 110 to transmit the output to the network 108. This step facilitates delivery of the output over the network 108 to the remote terminal 102, typically in the format that the web browser on the remote terminal 102 can utilize to generate the user interface 106. As noted herein, and shown in FIGS. 3, 4, 5, 6, 7, 8, 9, 10, 11, and 12, the data can configure the user interface 106 among a variety of configurations. Each of the configurations may serve a unique purpose, for example, to allow the end user to visualize and perform diagnostics on a specific, individual valve assembly. This feature is beneficial for the end user as it provides the end user with a robust, mobile diagnostic tool that is not effectively tethered to the conventional practice or modalities, i.e., the desktop computer.

In view of the foregoing, the embodiments above deploy features to arrange data on a user interface. These arrangements include a comprehensive set of data and/or data plots that reflect real-time, or near real-time, operation of assets. A technical effect is to provide a user interface that requires a minimum number of interactions for the end user to diagnose and/or obtain an understanding of the operation of individual valve assemblies.

One or more of the steps of the methods can be coded as one or more executable instructions (e.g., hardware, firmware, software, software programs, etc.). These executable instructions can be part of a computer-implemented method and/or program, which can be executed by a processor and/or processing device. The processor may be configured to execute these executable instructions, as well as to process inputs and to generate outputs, as set forth herein. For example, the software can run on the compressor, any related control device and/or diagnostics server, and/or as software, application, or other aggregation of executable instructions on a separate computer, tablet, laptop, smart phone, wearable device, and like computing device. These devices can display the user interface (also, a “graphical user interface”) that allows the end user to interact with the software to view and input information and data as contemplated herein.

The computing components (e.g., memory and processor) can embody hardware that incorporates with other hardware (e.g., circuitry) to form a unitary and/or monolithic unit devised to execute computer programs and/or executable instructions (e.g., in the form of firmware and software). Exemplary circuits of this type include discrete elements such as resistors, transistors, diodes, switches, and capacitors. Examples of a processor include microprocessors and other logic devices such as field programmable gate arrays (“FPGAs”) and application specific integrated circuits (“ASICs”). Memory includes volatile and non-volatile memory and can store executable instructions in the form of and/or including software (or firmware) instructions and configuration settings. Although all of the discrete elements, circuits, and devices function individually in a manner that is generally understood by those artisans that have ordinary skill in the electrical and software arts, it is their combination and integration into functional analog and/or digital and/or electrical groups and circuits that generally provide for the concepts that are disclosed and described herein.

Aspects of the present disclosure may be embodied as a system, method, or computer program product. The embodiments may take the form of an entirely hardware embodiment, an entirely software embodiment (including firmware, software, etc.) or an embodiment combining software and hardware aspects that may all generally be referred to herein as a “circuit,” “module” or “system.” The computer program product may embody one or more non-transitory computer readable medium(s) having computer readable program code embodied thereon.

In one embodiment, this disclosure contemplates a non-transitory computer readable medium comprising executable instructions stored thereon. Broadly, these instructions can embody one or more of the steps of the method 300, and its variants and embodiments, as noted herein. In one example, the executable instructions can comprise instructions for receiving a query over a network from a web browser launched on a first computing device; and generating an output with data for transmission over the network to the first computing device in response to the query, the data generating a user interface on the web browser that configures the web browser to display information about the plurality of valve assemblies, wherein the user interface is configured to conform to a form factor that defines physical attributes of the display on the second computing device, and wherein the user interface is configured to receive a user selection that reflects interaction of the end user with the user interface to define the query to change the information on the user interface to relate to an individual valve assembly from among the plurality of valve assemblies.

Computer program code for carrying out operations for aspects of the present invention may be written in any combination of one or more programming languages, including an object oriented programming language and conventional procedural programming languages. Program code embodied on a computer readable medium may be transmitted using any appropriate medium, including but not limited to wireless, wireline, optical fiber cable, RF, etc., or any suitable combination of the foregoing.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for presenting data on a display of a first computing device to understand operation of a plurality of valve assemblies, said method comprising:
at a server comprising a processor having access to executable instructions stored on a memory, the executable instructions comprising instructions for,
receiving a query over a network from a web browser launched on the first computing device; and
generating an output with data for transmission over the network to the first computing device in response to the query, the data generating a user interface on the web browser that configures the web browser to display information about the plurality of valve assemblies,
wherein the user interface is configured to conform to a form factor that defines physical attributes of the display on the first computing device, and
wherein the user interface is configured to receive a user selection that reflects interaction of an end user with the user interface to define the query to change the information on the user interface to relate to an individual valve assembly from among the plurality of valve assemblies.

2. The method of claim 1, further comprising:
transmitting the output to the network, wherein the data configures the user interface with a first data plot with data samples that define an operative parameter for the individual valve assembly in real-time.

3. The method of claim 2, wherein the data configures the user interface to allow the end user to set one or more parameters that define the data samples in the first data plot.

4. The method of claim 2, wherein the data configures the user interface with information defining a key performance indicator for the individual valve assembly.

5. The method of claim 2, further comprising:
transmitting the output to the network, wherein the data configures the first data plot with data samples that were previously-acquired and stored in memory.

6. The method of claim 2, further comprising:
transmitting the output to the network, wherein the data configures the user interface with a device tree having a plurality of device entries, each of the plurality of device entries corresponding to one of the plurality of valve assemblies, wherein the data further configures the user interface to allow the end user to select a first entry from among the plurality of the device entries to modify the user interface with information for display on the web browser that relates to the individual valve assembly that corresponds with the first entry.

7. The method of claim 6, wherein the data configures the user interface with information defining one or more non-operative attributes of the individual valve assembly, wherein the non-operative attributes distinguish the individual valve assembly from among the plurality of valve assemblies.

8. The method of claim 6, wherein the data configures the user interface with information that allows the end user to define the one or more non-operative attributes of the individual valve assembly.

9. The method of claim 6, wherein the data configures the user interface with information that allows the end user to populate the device tree with one or more additional valve assemblies from the plurality of valve assemblies.

10. The method of claim 9, wherein the user interface is configured for the end user to drag-and-drop the one or more additional valve assemblies to the device tree.

11. The method of claim 9, wherein the data configures the user interface with information that allows the end user to search for the one or more additional valve assemblies in accordance with a source that is connected to the one or more additional valve assemblies.

12. A system, comprising:
a diagnostic server comprising a processor with access to executable instructions stored on a memory, the executable instructions comprising instructions for,
receiving a query over a network from a web browser launched on a first computing device; and
generating an output with data for transmission over the network to the first computing device in response to the query, the data generating a user interface on the web browser that configures the web browser to display information about a plurality of valve assemblies,
wherein the user interface is configured to conform to a form factor that defines physical attributes of a display on the first computing device, and
wherein the user interface is configured to receive a user selection that reflects interaction of an end user with the user interface to define the query to change the information on the user interface to relate to an individual valve assembly from among the plurality of valve assemblies.

13. The system of claim 12, wherein the executable instruction comprise instructions for,
transmitting the output to the network, wherein the data configures the user interface with a first data plot with data samples that define an operative parameter for the individual valve assembly in real-time.

14. The system of claim 12, wherein the diagnostic server is configured to couple with a distributed control system, and wherein the executable instructions comprise retrieving data from the distributed control system.

15. The system of claim 12, wherein the data configures the user interface with a device tree having a plurality of device entries, each of the plurality of device entries corresponding to one of the plurality of valve assemblies, wherein the data further configures the user interface to allow the end user to select a first entry from among the plurality of device entries to modify the user interface with information for display on the web browser that relates to the individual valve assembly that corresponds with the first entry.

16. A computer-implemented user interface for configuring a web browser that is implemented on a computing device, the computer-implemented user-interface comprising:
a first content area for providing information in the form of a device tree with device entries that correspond to an individual valve assembly on a process line; and
a second content area for providing information about the individual valve assembly in response to interaction of an end user with one of the device entries on the web browser.

17. The computer-implemented user interface of claim 16, wherein the information in the second content area is configured with a first data plot that is configured to display data samples that define an operative parameter for the individual valve assembly in real-time.

18. The computer-implemented user interface of claim 17, wherein the information in the second content area is configured with at least one setting to define a diagnostic test that generates the data samples for the first data plot.

19. The computer-implemented user interface of claim 17, wherein the second content area comprises a first device data area and a second device data area, wherein the first device data area is configured to provide information that defines non-operative attributes of the individual valve assembly, and wherein the second device data area is configured with the first data plot.

20. The computer-implemented user interface of claim 19, wherein the first device data area is configured to provide one or more visual indicators that relate to data about a performance indicator for the individual valve assembly.
